(19) United States
(12) Patent Application Publication
(10) Pub. No.: US 2015/0308357 A1
(43) Pub. Date: Oct. 29, 2015

(54) ENGINE CONTROL UNIT FOR A SELF-IGNITING INTERNAL COMBUSTION ENGINE AND METHOD FOR OPERATING A SELF-IGNITING INTERNAL COMBUSTION ENGINE

(71) Applicant: Schaeffler Engineering GmbH, Werdohl (DE)

(72) Inventors: Lars Pfützenreuter, Werdohl (DE); Dirk Neubauer, Nachrodt-Wiblingwerde (DE)

(21) Appl. No.: 14/648,270

(22) PCT Filed: Dec. 3, 2013
(86) PCT No.: PCT/DE2013/200332

§ 371 Date: May 29, 2015

(30) Foreign Application Priority Data
Dec. 6, 2012 (DE) 10 2012 222 368.1

(51) Int. Cl. F02D 19/10; F02M 21/04; F02D 41/00

(52) U.S. Cl. CPC F02D 19/10; F02D 41/0027; F02M 21/047

(57) ABSTRACT

The invention relates to a method for operating an internal combustion engine with autoignition capability using a first, autoignitable fuel and a second, non-autoignitable fuel. A self-igniting operation of said type is made considerably simpler in relation to the prior art by means of the following method steps: a) detecting a setpoint value change for the operation of the internal combustion engine which requires an increase of the fuel flow rate to be supplied to the internal combustion engine, b) increasing the flow rate of the first fuel supplied to the internal combusion engine to a value that effects a follow-up adjustment of the actual value associated with a setpoint value, wherein the supplied flow rate of the second fuel initially remains unchanged, c) newly calculating and controlling the flow rates of the first and second fuels to be supplied to the internal combustion engine such that the actual value continues to correspond to the setpoint value and the flow rate of the first fuel is reduced in relation to the flow rate determined in step b) but remains high enough to effect autoignition of the mixture of first and second fuel and air.

### FIELD

Engine control unit for a self-igniting internal combustion engine and method for operating a self-igniting internal combustion engine

### BACKGROUND

The invention relates to a device and a method for operating a so-called dual fuel engine. A dual fuel engine as it relates to the invention is understood to mean an internal combustion engine with auto-ignition which can be operated with at least two different fuels. Of the at least two different fuels, at least one is auto-igniting and at least one is not auto-igniting.

Internal combustion engines which are auto-igniting are characterised in that the air-fuel mixture is compressed until it auto-ignites without the need for an external ignition source, such as a spark plug.

In the case of a dual fuel engine, this first auto-igniting fuel is mixed with a second non-auto-igniting fuel. A motor of this type has to be operated such that sufficient auto-igniting fuel is present in the mixture to ignite due to the compression, thus causing the non-auto-igniting fuel to ignite also. Accordingly, the auto-igniting fuel acts as an ignition means for the non-auto-igniting fuel in an internal combustion engine of this type with dual fuel operation.

Diesel fuel is frequently used in this case as a first auto-igniting fuel. A second non-auto-igniting fuel, i.e. natural gas, methane, biogas, liquefied gas, propane, butane, hydrogen or ethanol, is added to this in order to achieve improved emission values compared with pure diesel operation, as well as to save fuel.

According to prior art, the mixing of gaseous fuels requires complex gas supply facilities which call for a large number of components and control devices and are extremely costly as a result. Besides an LPG/CNG tank, a pressure regulator, various shut-off valves and numerous inlet gas valves, above all an additional and expensive control device with appropriate final stages for the inlet valves is necessary.

DE102007022230A1 discloses an apparatus for controlling an auto-ignition internal combustion engine with dual-fuel operation and a method for operating it. For this, two engine control devices are provided of which one first unit controls the delivery of a first, auto-igniting fuel. Furthermore, this document provides for a second, separate engine control device which feeds an amount of an alternative non-auto-igniting fuel to the engine matched to a given load. In the method disclosed in this document, an overall set point value is first calculated based on the setting of an accelerator and the set point value is divided into a first and second partial set point value. The first partial set point value is sent to the first engine control device which then calculates the amount of the first auto-igniting fuel to feed to the internal combustion engine. Based on the second partial set point value, the second control unit determines the amount of the second, for example, gaseous, non-auto-igniting fuel.

### SUMMARY

The problem underlying the invention is to simplify the operation of an auto-ignition internal combustion engine with two different fuels.

This problem is resolved by a method to operate an auto-igniting internal combustion engine with a first auto-igniting fuel and a second non-auto-igniting fuel with the method steps of a) acquisition of a change in the set point value for the operation of the internal combustion engine which requires an increase in the amount of fuel to be fed to the internal combustion engine, b) increase in the amount of the first fuel fed to the internal combustion engine to a value which effects adjustment of the actual value associated with the set point value wherein the amount of the second fuel supplied initially remains unaltered, and c) recalculation and control of the amounts of the first and second fuels to be fed to the internal combustion engine such that the actual value continues to correspond to the set point value and the amount of the first fuel is reduced compared with the amount determined in step b), but is still sufficiently large to effect auto-ignition of the mixture of first and second fuel with air.

Furthermore the problem is resolved by an engine control device for operation of an auto-igniting internal combustion engine with a first auto-igniting fuel and a second non-auto-igniting fuel with the features where the engine control includes a signal input for a set point value for operating the internal combustion engine; means to regulate the amount of the first fuel fed to the internal combustion engine as a function of the set point value; and means to calculate and control the amounts of the first and second fuels to be fed to the internal combustion engine such that the actual value corresponds with the set point value and the amount of the first fuel is sufficiently large to effect auto-ignition of the mixture of first and second fuel with air, wherein the engine control device is configured such that, when a set point value is changed which requires an increase in the amount of fuel to be fed to the internal combustion engine, first the supply of the amount of first fuel is increased and, only when this is concluded, a new apportionment of the air-fuel mixture regarding first and second fuel is redetermined and regulated, wherein the amount of the first fuel is reduced but is still sufficiently large to effect auto-ignition of the mixture of first and second fuel with air.

Advantageous embodiments of the invention can be found in the dependent patent claims.

The invention is based on the recognition that a dual fuel operation of an auto-igniting internal combustion engine can be simplified significantly compared with the prior art known up to the present such that the driver's request for a certain dynamic level in the power unit is served by a control loop which is separate from a control or regulation of the fuel ratios for meeting the exhaust emissions regulations.

According to the invention, first a set point change is acquired for the operation of the internal combustion engine which requires an increase in the amount of fuel being fed to the internal combustion engine. A set point change of this kind can be derived from a changed accelerator setting in an advantageous embodiment of the invention. Thus, if, for example, the driver depresses the accelerator more vigorously, then he expects a rapid response from the “vehicle” system which, again, places high demands on the power unit dynamics.

By doing this, it can be found that the change in the set point value initially causes a reaction with an increase in the amount of the first fuel being fed to the internal combustion engine to a value which effects adjustment of the actual value associated with the set point value. In doing so, the amount of the second fuel supplied initially remains unaltered. If the first auto-igniting fuel involved is diesel, there is a reaction to the change in the set point value, just the same as in the case of a conventional diesel engine by an increase in the amount of injected diesel fuel. Accordingly, this regulation task can be managed even by a commercially available engine control device for diesel engines. At the instant that the proportion of auto-igniting fuel is raised and the non-auto-igniting fuel proportion initially remains the same, the exhaust emissions values generally may well worsen temporarily. Nevertheless the mixture still auto-ignites.

Subsequent to this method step, a recalculation and control of the amounts of the first and second fuels to be fed to the internal combustion engine are carried out such that the actual value continues to correspond to the set point value and the amount of the first fuel is reduced compared with the amount determined previously, but is still sufficient to effect auto-ignition of the mixture of first and second fuel with air. The recalculation of the ratio of first to second fuel therefore takes place more slowly than the adjustment of the actual value to the set point value. This is the manner by which the composition of the volumetric gas flow is metered precisely according to exhaust emission factors, wherein, however, a certain time delay has to be allowed for due to the longer time constants of the control loop, or, respectively, the slower control system.

In an advantageous embodiment of the invention, the method steps are performed by a single engine control device so that the considerable costs for a further engine control device can be saved.

An engine control device suitable for performing the method according to the invention comprises a signal input for a set point value for the operating of the internal combustion engine, means to regulate the amount of the first fuel fed to the internal combustion engine as a function of the set point value, and means to calculate and control the amounts of first and second fuels to be fed to the internal combustion engine, such that the actual value corresponds to the set point value and the amount of the first fuel is sufficiently large to effect auto-ignition of the mixture of first and second fuel with air. Said means can be formed as logic circuits with one or a multiplicity of microprocessors, digital signal processors and/or programmable logic modules such as FPGAs or CPLDs in conjunction with commercially available memory modules. Also, the use of ASICs is conceivable and is naturally encompassed by the invention. Said engine control device is configured in particular by hardware programming such that, when a set point value is changed which requires an increase in the amount of fuel to be fed to the internal combustion engine, first the supply of the amount of first fuel is increased and, only when this is concluded, a new apportionment of the air-fuel mixture regarding first and second fuel is redetermined and regulated, wherein the amount of the first fuel is reduced but is still sufficiently large to effect auto-ignition of the mixture of first and second fuel with air.

When, advantageously, diesel is used as the first fuel and gas as the second fuel, in a further embodiment of the invention, the amount of gas can be fed via a gas volume mixer, in particular a venturi mixer, arranged in the air intake duct of the internal combustion engine, wherein the gas volume mixer is controlled by a gas pressure regulator. In doing so, in a further embodiment of the invention, the single engine control device can send a pressure set point value to the pressure regulator, said value being determined in the engine control device based on the recalculated amount of gas in accordance with the invention.

In this, the hardware, if necessary slightly modified, of a commercially available engine control device for a diesel engine can be used as the engine control device. When the driver depresses the accelerator, the engine control device first receives the set point value change associated with it for the operation of the internal combustion engine and calculates an increase in the amount of fuel corresponding to it. Just as with a conventional diesel engine, the engine control now meets the demand for more power simply by increasing the amount of diesel fuel injected. This takes place with the same effort and the same dynamics as is the case with conventional diesel engines. With a comparatively high time constant, a new calculation is performed in parallel in the same engine control device to determine the fuel composition which is ideal from an emission viewpoint. A determination is therefore made with somewhat reduced dynamics as to what extent the additionally injected amount of diesel fuel can be substituted by mixing gas into the air supply of the internal combustion engine. In an advantageous embodiment of the invention, the result of this recalculation is an input value for the said gas pressure regulator which controls, for example, a venturi mixer.

An engine control unit, which has an engine control device according to one of the embodiments of the invention quoted above, and comprising a gas volume mixer and an associated gas pressure regulator, may be incorporated in a particularly simple manner in the combustion section of an auto-igniting internal combustion engine. For this, simply a gas volume mixer has to be installed in the air intake duct of the internal combustion engine, said gas volume mixer being regulated by the gas pressure regulator. The gas pressure regulator preferably receives a pressure set point value from a signal output of the engine control device. In this case, the engine control device comprises preferably means to determine the pressure set point value as a function of an amount of the second fuel to be fed to the internal combustion engine. Compared with the components otherwise needed to operate a diesel engine, all that is needed is simply, therefore, a gas volume mixer with an additional gas pressure regulator, wherein the commercially available engine control device has to be configured with extended functionality, as described above.

### BRIEF DESCRIPTION OF THE DRAWING

FIG. 1 shows schematically the operation of a diesel engine with two different fuels of which one is auto-igniting.

### DETAILED DESCRIPTION

The invention is described below with the aid of the exemplary embodiment illustrated in the drawing.

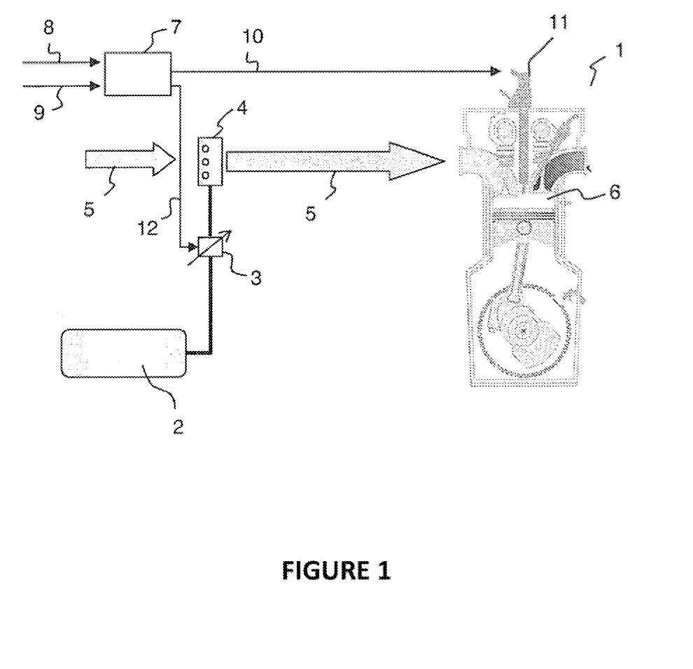

FIG. 1 shows schematically the operation of a diesel engine with two different fuels of which one is auto-igniting. According to this, the invention is shown by way of an example using an auto-igniting internal combustion engine which can be operated with diesel fuel. The internal combustion engine is represented by a cylinder 1 of the diesel engine.

In addition to the auto-igniting diesel fuel, the internal combustion engine can be supplied also with a second non-auto-igniting fuel, in this case involving compressed natural gas (CNG) as an example. The CNG is stored in a fuel tank 2. With the aid of a pressure regulator 3, the CNG can be fed to a venturi mixer 4. The venturi mixer 4 is incorporated in the air intake duct 5 of the internal combustion engine. Accordingly, the combustion chamber 6 of cylinder 1 is supplied with a mixture of air, diesel fuel and CNG.

The composition of the air-fuel mixture is regulated by an engine control device 7 in a closed loop or in an open control system. As with any conventional engine control device 7, this unit also comprises a number of analogue and digital input and output interfaces which are connected to sensors and actuators. Furthermore, a CAN bus interface, not shown, is provided on the engine control device 7 for communicating with other control devices in the vehicle.

The input signal for the engine control device 7 is indicated in a highly simplified manner to be the accelerator setting 8 and the engine rpm 9. Again, highly simplified, output quantities are a first set point value 10 for a diesel injection nozzle 11 and a second set point value 12 for the pressure regulator 3. Other input and output quantities, such as the engine rpm, the throttle-valve angle, the air mass flow, temperatures and pressures, lambda probe and knocking sensor signals, setting quantities for the throttle-valve adjuster, the exhaust gas recirculation valve, a turbocharger and camshaft adjustment, etc., are not shown in the drawing since they do not contribute to an understanding of the invention.

When considering a static power requirement for the internal combustion engine, from an emissions standpoint there is an optimal apportionment of diesel fuel and gas in the required amount of fuel. For example, using the appropriate characteristic curves, the engine control device 7 determines this apportionment and initiates the corresponding fuel feed by means of the set point quantities 10, 12. If the power requirement for the engine changes particularly quickly, such as by actuating the accelerator, the engine control device 7 reacts in the following manner to an increase in the power requirement:

First, the new accelerator setting 8 is acquired. The engine control device 7 establishes that the accelerator has been depressed more and, thus, calculates an additional amount of diesel fuel which is required to meet the increased request for power. The control loop needed for this corresponds essentially to the control loop of a conventional diesel engine and has comparable dynamics also. Therefore, the vehicle reacts to the driver's request with the same dynamics as would be the case with a conventional diesel motor vehicle. In a similar fashion, though less dynamically, a new calculation of the fuel mixture is carried out which will still meet the power requirement but which is optimised with regard to emission factors. This means that, after this, a part of the amount of diesel fuel being injected according to the accelerator setting is reduced further and is compensated by a supply of CNG through the venture mixer 4. For this purpose, appropriate characteristic curves stored in the engine control 7 are interpreted again by the engine control 7. The engine control 7 then calculates a second set point value 12 which serves as an input signal to the pressure regulator, and a new set point value 10 for the diesel injection. In this manner, the gas volumetric flow is metered precisely, although with a certain time delay due to the longer time constant of the gas-air control system.

### LIST OF REFERENCES

1 Cylinder
2 Fuel tank
3 Pressure regulator
4 Venturi mixer
5 Air intake duct
6 Combustion chamber
7 Engine control device
8 Accelerator setting
9 Engine rpm
10 First set point value
11 Diesel injection pump
12 Second set point value

1. Method for operating an auto-igniting internal combustion engine with a first auto-igniting fuel and a second non-auto-igniting fuel comprising the following method steps:
a) acquiring a change in the set point value for the operation of the internal combustion engine which requires an increase in the amount of fuel to be fed to the internal combustion engine,
b) increasing the amount of the first fuel fed to the internal combustion engine to a value which effects adjustment of the actual value associated with the set point value wherein the amount of the second fuel supplied initially remains unaltered,
c) recalculating and controlling the amounts of the first and second fuels to be fed to the internal combustion engine such that the actual value continues to correspond to the set point value and the amount of the first fuel is reduced compared with the amount determined in step b), but is still sufficiently large to effect auto-ignition of the mixture of first and second fuel with air.

2. Method according to claim 1, wherein the change in set point value is derived from a change in the accelerator setting.

3. Method according to claim 1, wherein the method steps a) to c) are performed with a single engine control device.

4. Method according to claim 1, wherein diesel is used as the first fuel and gas as the second fuel.

5. Method according to claim 4, wherein the amount of gas is fed via a gas volume mixer, in particular a venturi mixer arranged in an air intake duct of the internal combustion engine, wherein the gas volume mixer is controlled by a gas pressure regulator.

6. Method according to claim 5, wherein the single engine control device sends a pressure set point value to the pressure regulator, said value being determined in the engine control device based on the amount of gas recalculated in method step c).

7. Engine control device for operating an auto-igniting internal combustion engine with a first auto-igniting fuel and a second non-auto-igniting fuel wherein the engine control comprises a signal input for a set point value for operating the internal combustion engine, means to regulate the amount of the first fuel fed to the internal combustion engine as a function of the set point value and means to calculate and control the amounts of the first and second fuels to be fed to the internal combustion engine such that the actual value corresponds with the set point value and the amount of the first fuel is sufficiently large to effect auto-ignition of the mixture of first and second fuel with air, wherein the engine control device is configured such that, when a set point value is changed which requires an increase in the amount of fuel to be fed to the internal combustion engine, first the supply of the amount of first fuel is increased and, only when this is concluded, a new apportionment of the air-fuel mixture regarding first and second fuel is redetermined and regulated, wherein the amount of the first fuel is reduced but is still sufficiently large to effect auto-ignition of the mixture of first and second fuel with air.

8. Engine control unit comprising
an engine control device according to claim 7 with a signal output for a pressure set point value,
a gas volume mixer that is installable into the air intake duct of h internal combustion engine, in particular a venturi mixer, and
a gas pressure regulate with a signal input for the pressure set point value,
wherein the engine control device has means for determining the pressure set point value as a function of an amount of the second fuel to be fed to the internal combustion engine.

9. Method according to claim 2 wherein the method steps a) to c) are performed with a single engine control device.

10. Method according to claim 2 wherein diesel used as h first fuel and gas as the second fuel.

11. Method according to claim 3 wherein diesel is used as he first fuel and gas as the second fuel.

12. Method according to claim 9 wherein rein diesel is used as the first fuel and gas as the second fuel

13. Method according to claim 4, wherein the amount of as is fed via a gas volume mixer, in particular a venturi mixer arranged in an air intake duct of the internal combustion engine, wherein the gas volume mixer is controlled by a gas pressure regulator.

14. Method according to claim 10, wherein the amount of gas is fed via a gas volume mixer, in particular a venturi mixer arranged in an air intake duct of the internal combustion engine, wherein the gas volume mixer is controlled by a gas pressure regulator.

15. Method according to claim 12, wherein the amount of gas is fed via a gas volume mixer, in particular a venturi mixer arranged in an air intake duct of the internal combustion engine, wherein the gas volume mixer is controlled by a gas pressure regulator.

16. Method according to claim 5, wherein the single engine control device sends a pressure set point value to the pressure regulator, said value being determined in the engine control device based on the amount of gas recalculated in method step c), and wherein the change in set point value is derived from a change in the accelerator setting.

17. Method according to claim 5, wherein the single engine control device sends a pressure set point value to the pressure regulator, said value being determined in the engine control device based on the amount of gas recalculated in method step c), and wherein the method steps a) to c) are performed with a single engine control device.

18. Method according to claim 5, wherein the single engine control device sends a pressure set point value to the pressure regulator, said value being determined in the engine control device based on the amount of gas recalculated in method step c), wherein the change in set point value is derived from a change in the accelerator setting and the method steps a) to c) are performed with a single engine control device.
